(19) United States
(12) Patent Application Publication
(10) Pub. No.: US 2004/0045020 A1
(43) Pub. Date: Mar. 4, 2004

(54) Commercial identification system

(76) Inventors: Jeffrey Michael Witt, Portland, OR (US); Steve Ferber, Portland, OR (US)

Correspondence Address: Kevin L. Russell, Chernoff, Vilhauer, McClung & Stenzel, LLP, 1600 ODS Tower, 601 S.W. Second Avenue, Portland, OR, 97204-3157, US

(21) Appl. No.: 10/233,328

(22) Filed: Aug. 29, 2002

(51) Int. Cl. H04N 7/16; H04H 9/00

(52) U.S. Cl. 725/13; 725/22; 725/142; 348/700

(57) ABSTRACT

A system for the identification of commercials within a video.

### BACKGROUND OF THE INVENTION

The present invention relates to a commercial identification system.

In the early days of video broadcasting there existed only a limited number of available broadcast channels. In addition, there existed a limited number of video choices, such as movies, news, and sitcoms. To view a particular broadcast, the user needed to make sure he was available during the time that the desired content was broadcast. With a relatively limited amount of content available and a relatively limited number of broadcast channels this requirement for concurrent viewing of the content with the broadcast was not excessively burdensome.

With the extensive development of additional sources of broadcast content together with the decreased ability of users to view the broadcast content concurrent with its broadcast, the concurrent viewing of all potentially desirable content has become a burdensome task. The development of a video cassette recorder (VCR) provides a partial solution to the need for concurrent viewing of content with its broadcast. The VCR permits viewers to record one or more selected programs, or portions thereof, onto a tape. Selecting the times for recording may be performed manually at a time concurrent with the start of the content broadcast or otherwise programmed into the VCR to record particular broadcast content at a later time. The tape may then be subsequently played to permit the user to watch previously recorded content. The VCR also permits the user to perform several other functions, such as for example, play, pause, rewind, fast-forward, slow play, slow rewind, fast-reverse, and step frame-by-frame forward or reverse. For example, the user of a VCR may fast forward the video playback through undesirable material, such as commercials. Also, some VCR's include a thirty second skip feature. This ability to time-shift playback of video content broadcasts and to control the flow and sequence of content playback has dramatically empowered viewers. VCRs are now present in the majority of American homes.

Unfortunately, a traditional single tape VCR is not typically capable of both simultaneously recording video content while playing back different video content. In addition, if the user is simultaneously watching and recording a broadcast for later viewing, the user can not rewind the tape to watch a previously recorded event while simultaneously recording the remainder of the broadcast content. In this manner, the user is limited to either terminating the recording of the broadcast content and watching the previously recorded event, or otherwise recording the remainder of the broadcast content and then later watching the previously recorded event.

Subsequent to the development of the VCR, multimedia (e.g., video and audio) computer based broadcast content recording systems have been developed. These multimedia systems include recording media to record broadcast content thereon. One of the advantages of the multimedia systems is the ability to access and view selections from a collection of recorded programs in a nearly instantaneous manner without the need to rewind or fast-forward a tape. Another advantage of such systems include the ability to start recording a program from its beginning while simultaneously watching the program at a later time prior to the end of the program being broadcast. In essence, this permits the simultaneous recording and delayed viewing of the same broadcast content. Yet another advantage of such systems is the ability to skip ahead a predetermined time period, such as 30 seconds, by pressing a button on a remote control. For example, this skipping capability is useful when a commercial occurs and the user does not desire to view the commercial. Some systems incorporate a multi-speed fast -forward, e.g., three times, ten times and sixty times the normal speed. This permits the user to essentially skip over commercials while still experiencing the commercial, at least in shortened format. TiVo generally refers to such products as multimedia time-warping systems.

One example of how such a multimedia system may be used is as follows:

in one multimedia system implementation, the user may start viewing a broadcast program 10 minutes after the start of the broadcast program. The broadcast program is recorded by the multimedia system during the entire duration of its broadcast. When a commercial of the broadcast program is presented to the user, the user may use a fast-forward feature or a skip-ahead feature (such as skip ahead 30 seconds), to manually skip over undesirable portions of the broadcast. The fast forward or skip features change the normal playback flow (i.e., flow control) of the video, while at the same time, the system continues to record the broadcast program for subsequent viewing. With this ability to “skip” portions of the broadcast program, the user has an incentive to habitually time-shift/delay viewing of all broadcast programs until after they start broadcasting. Moreover, this ability to “skip” portions of the broadcast program also provides a strong incentive to avoid watching any commercials.

While the capability to skip commercials is beneficial when using multimedia systems, the user is typically required to manually activate the fast-forward or skip-ahead features. To manually activate the fast-forward or skip-ahead features the user needs to be attentive and have the remote control at hand so as to be ever wary for the potential of commercial segments. Even the most attentive commercial skipper will still inevitably view a small fraction of each commercial (or the first commercial in a set of continuous commercials) before activating the fast-forward or skip-ahead features again. Unfortunately using the skip-ahead feature may result in inadvertently skipping ahead slightly too much, thereby missing a portion of the resumed broadcast program. It is to be noted that some systems, such as TiVo, intervene a few future frames to the current playback location so that while fast forwarding some future scenes are presented to the user. With the user being aware of the future scenes it is somewhat easier for the user to more accurately end the fast forward at the end of the commercial.

There have been attempts to develop automatic commercial skipping features. The automatic commercial skipping features analyze the content of the video searching for identifiable segments of a typical commercial. While such a technique typically works, it relies on the broadcasters to include the requisite identifiable content to define the commercial segments there between. However, this technique sometimes results in commercials not being properly detected or otherwise skipping portions that are not commercials.

What is desired, therefore, is an improved commercial identification technique.

### BRIEF DESCRIPTION OF THE DRAWINGS

FIG. 1 is an illustration of a set top box.

FIG. 2 illustrates a video buffer.

FIG. 3 illustrates a video buffer.

FIG. 4 illustrates a video buffer and commercial.

FIG. 5 illustrates a video buffer and commercial.

FIG. 6 illustrates a set top box and server system.

FIG. 7 illustrates data from a 30-second skip-ahead feature.

FIG. 8 illustrates data from a fast-forward feature.

FIG. 9 illustrates a set of commercials.

FIG. 10 illustrates a set of commercials in an automatic skip commercial filter.

### DETAILED DESCRIPTION OF THE PREFERRED EMBODIMENT

The present inventors considered the current multimedia systems and whether improved commercial detection mechanisms would ever be sufficiently robust to deliver reliable commercial skipping. For example, attempting to identify commercials based on their content is difficult. After considered thought the present inventors determined that it was unlikely that the content-based commercial detection mechanism would ever be robust enough to accurately detect all commercial content.

Based upon the realization that the existing content-analysis systems are inherently fallible, the present inventors then determined that the viewing habits for a particular program of a collection of users provides valuable insight into the type of content that is being viewed. In particular, there is a tendency for users as a whole to fast forward or otherwise skip over largely the same segments of recorded programs, which are generally the commercial segments. In other words, users of multimedia recording systems quite reliably identify the general location of the commercial segment by their skip or fast-forward behavior. By analyzing the content of data representing fast-forward and skip-ahead behavior from a portion of the early post broadcast program viewing audience, and from that data programmatically inferring the actual segments of the original broadcast program that are commercials, and distributing the analyzed data to the remaining (later) viewers' playback devices, one may allow other later viewers of that same program to automatically skip over the commercial segments during playback.

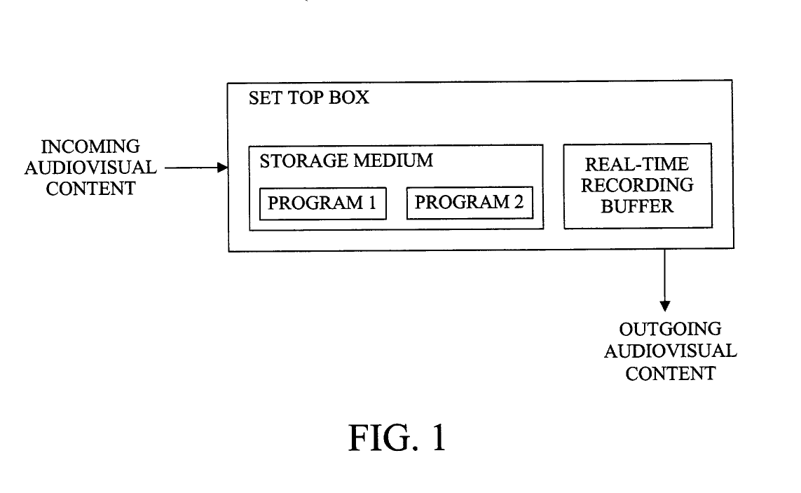

Referring to FIG. 1, a set top box typically receives audiovisual content and records the audiovisual content onto a storage medium, such as a hard drive, a compact disc, a memory, or a digital video disc. Normally, the storage medium includes the capability of recording several hours of audiovisual content. The set top box may also include a real-time recording buffer that is used in conjunction with live broadcasts, such as 30-120 minutes, that permits the user to modify the presentation of the recently broadcast audiovisual content. For example, the real-time recording buffer may permit the user to rewind a portion of the current broadcast content for viewing again, pausing the content when answering the phone and resuming the content at the point paused, and fast forward the content. In some implementations, the real-time recording buffer may be a circular buffer that is always writing the incoming data over the oldest data within the buffer. A more detailed description of the functions of several examples of a set top box are described in U.S. Pat. Nos. 6,327,418; 6,310,886; 6,233,389; 6,216,526, incorporated by reference herein.

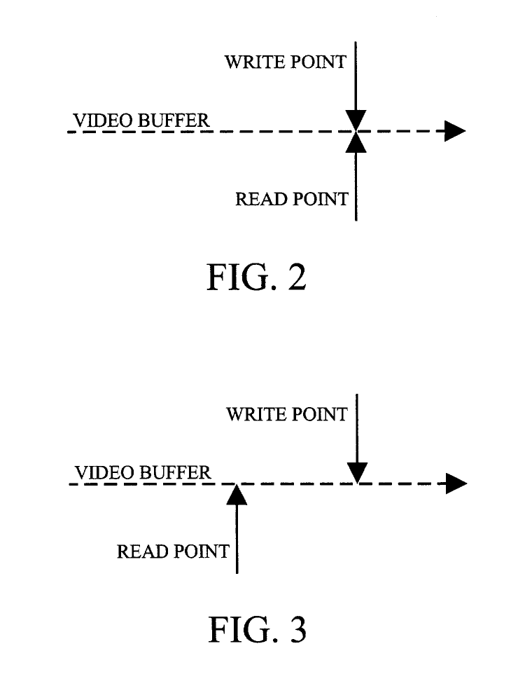

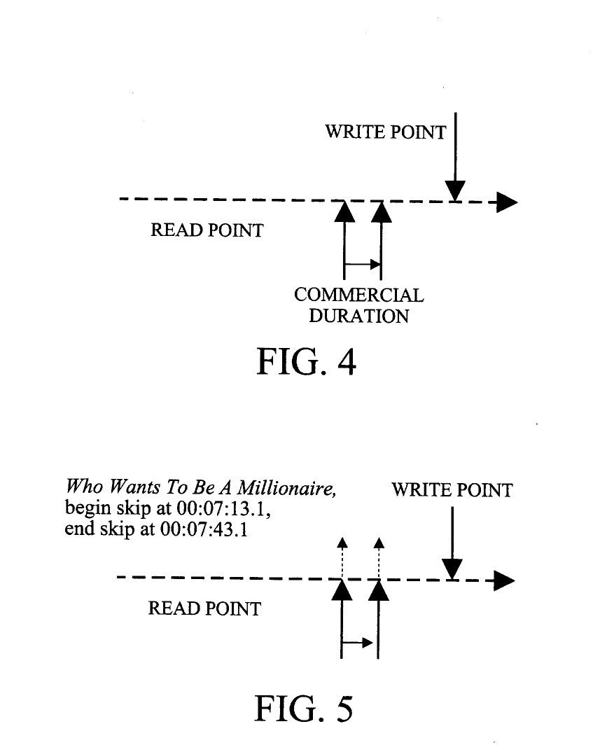

Referring to FIG. 2, by way of illustration, when viewing a live broadcast the device's play function reads from the real-time buffer, or otherwise presents the incoming broadcast, while simultaneously writing to the real-time buffer. In this case the write point in the video time line may be considered substantially the same as the read point in the time line. Referring to FIG. 3, if the viewer pauses the viewing of the live broadcast or otherwise delays viewing the live broadcast, then the read point in the time line lags behind the write point in the time line. Referring to FIG. 4, if there is a sufficient lead between the read point in the time line and the write point in the time line then the viewer may skip over commercials in the program using the fast-forward or skip feature, such as a 30 second skip ahead feature.

With the present inventors' realization that viewers have a tendency to fast forward or otherwise skip commercial portions of the programs, this activity or event may be used, at least in part, as the basis of determining when commercials occur in a particular broadcast. Referring to FIG. 5, if the viewer is watching a program, such as Who Wants to Be A Millionaire, the viewer may begin a skip at 00:07:13.1 and end the skip at 00:07:43.1. The activation of the skip feature may indicate the presence of a commercial or otherwise a portion of the program that is undesirable to the viewer. The system may record the activation of a skip feature or otherwise a fast forward feature, together with the associated program and/or part thereof, as desired. Also, the system may detect and store several such events for further usage.

The present inventors came to the further realization that by accumulating several such events from different users viewing the same program, a more reliable statistical inference of undesirable portions of a program may be determined. If multiple such devices are interconnected to a network, such as the Internet, then this data may be provided to a server. The data may include, for example, fast-forward and skip-ahead intervals associated with the programs being viewed. The fast-forward and/or skip-ahead intervals may be associated with their respective programs and portions thereof in any suitable manner.

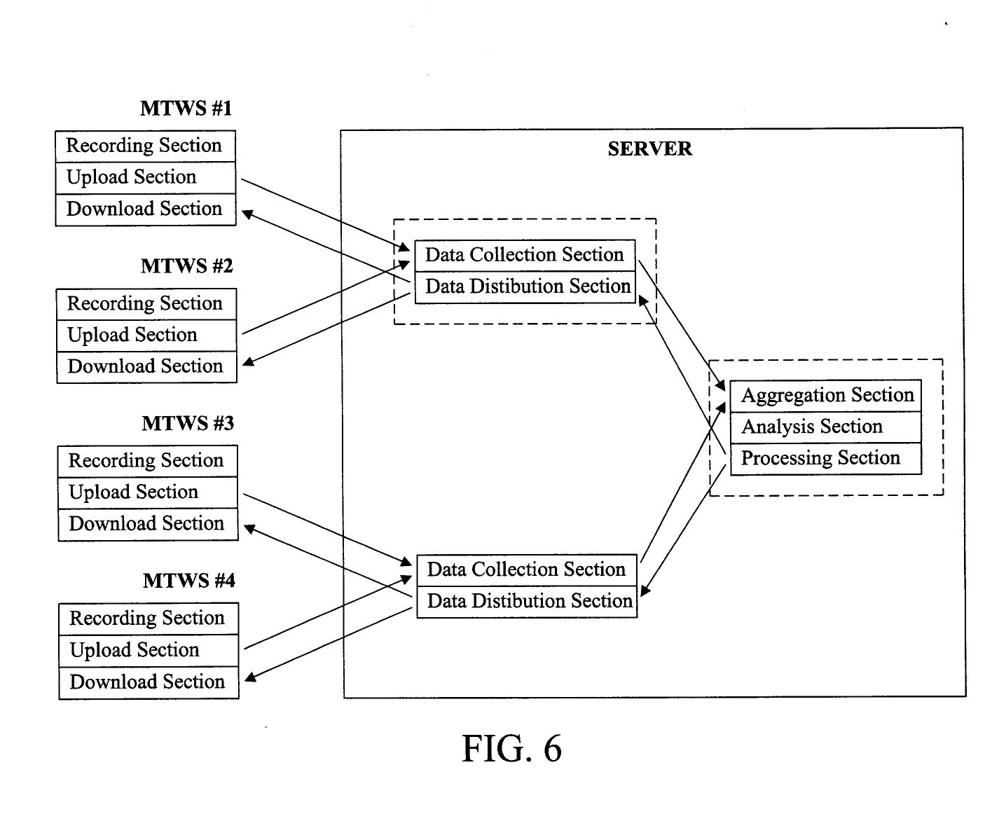

Referring to FIG. 6, a plurality of recording devices (e.g., multimedia systems), sometimes referred to as multimedia time warping systems may be interconnected or otherwise capable of communicating with one or more servers, normally through a network. The fast-forward and/or skip-ahead interval data acquired by each recording device for one or more programs may be transferred to data collection portions of the server. The data collection portions of the server may, in turn, pass the data to an aggregation portion of the server for further analysis.

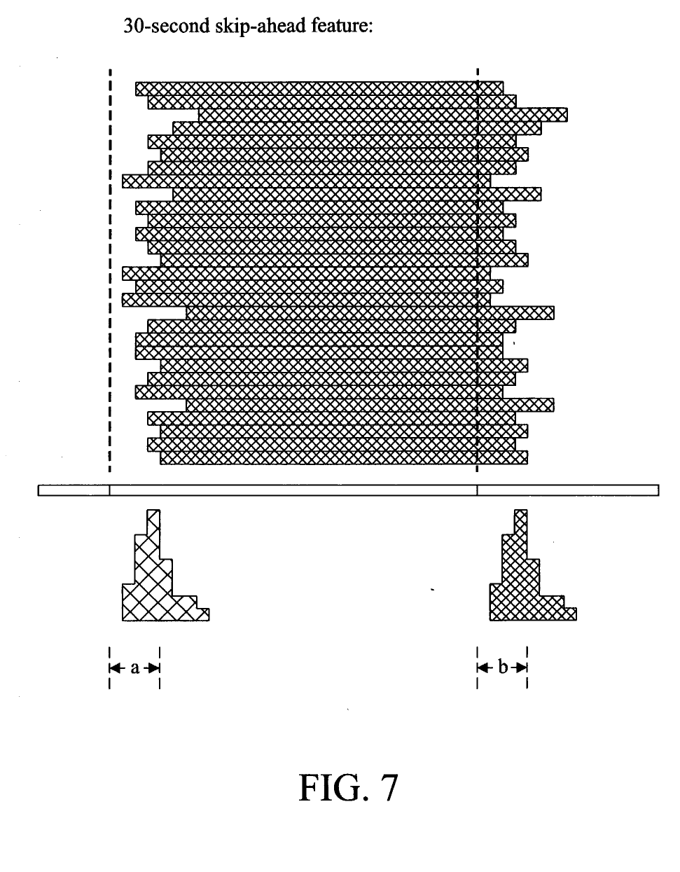

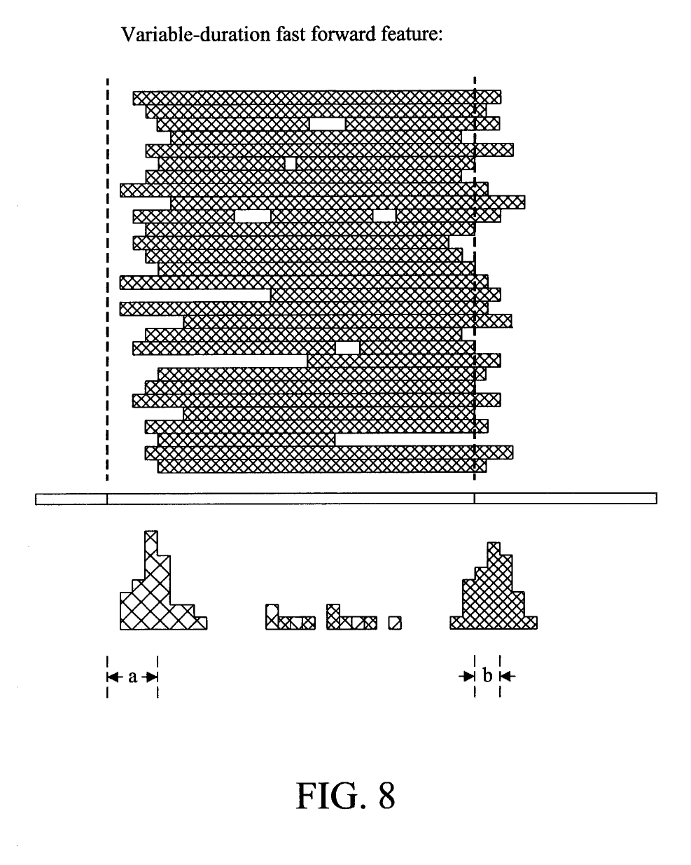

Referring to FIGS. 7 and 8, data representing the fast forward/skip-ahead portions of a particular program from different users is illustrated. The data may include a plurality of viewers who have activated the fast-forward feature (see FIG. 8) and/or skip-ahead interval (see FIG. 7) feature at approximately the same time for the same portion of the same program. As shown, since the user typically will not press the fast-forward or skip-ahead interval at the precise start of the commercial, there is normally a latency between the actual start of the commercial and the time by which the user activates the fast-forward or skip-ahead interval. By statistical processing, such as using the mode or any other measure, a statistical measure of when the users typically started the fast-forward, skip-ahead interval may be determined. Similarly, since the user typically will not de-press the fast-forward at the precise end of the commercial or the skip-ahead interval will not cease at the precise end of the commercial, there is normally a latency between the actual end of the commercial and the time by which the user de-activates the fast-forward or skip-ahead interval ceases. By statistical processing, such as using the mode or any other measure, a statistical measure of when the users typically ends the fast-forward may be determined or the overshoot (or under shoot) of the skip-ahead interval may be determined. With a sufficient number of users fast-forwarding or skipping-ahead the same portion of the same program, the location of commercials or otherwise undesirable content may be inferred with some degree of confidence. In addition, the duration of the fast-forward and/or skip-ahead interval may be used to further determine if a commercial was likely, such as 15, 30, or 60 seconds.

With a statistical measure of the detected start of a potential commercial together with information regarding a typical (or calculated) latency, if desired, the system may determine the start of the commercial with some reasonable degree of confidence. Similarly, with some statistical measure of the end of a potential commercial together with information regarding a typical (or calculated) latency, if desired, the system may determine the end of the commercial with some reasonable degree of confidence. In addition, the anticipated durations of commercials, such as 15, 30, or 60 seconds, may be used to further refine the start and/or end of the detected commercial. Further, the statistical measure may be based upon the temporal resolution of the data, such as millisecond or ¼ second accuracy, and/or the quantity of data. For example, with a relatively limited amount of user data having high temporal resolution, the histogram of the data will tend to be relatively flat. The mode may not be highly accurate for such data. With a relatively limited amount of data having low temporal resolution, the histogram of the data will tend to be pointed. A balance between the amount of data and its temporal resolution will permit the system to readily determine meaningful statistics.

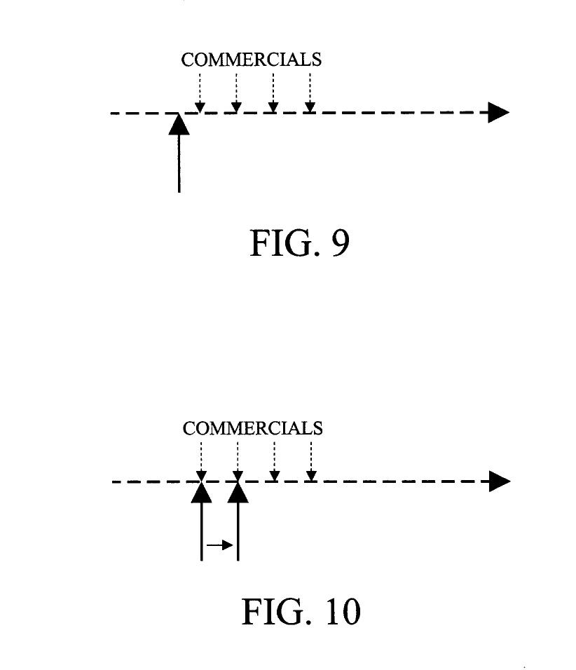

Once sufficient fast-forward or skip-ahead interval data has been accumulated and analyzed for a particular program, information regarding the location of the commercials for a particular program may be provided to the data distribution sections of the server. Prior to other user's providing data to the system, the location of the commercials may be unknown. The data distribution sections then distribute the processed data to the devices either in bulk or selectively. The data may be used by the devices together with viewing the associated programs. Now, with processed data from other users, the location of the commercials may be known. This provides an incentive to the user to time-shift his viewing. Referring to FIG. 9, this data may be presented to the user or otherwise made available to the user in some manner so that the user and/or device is aware of future commercials (or otherwise portions of the video to skip) that the user may wish to skip or otherwise not view in normal play mode. For example, an indicator displayed to the user may indicate portions of the video that are commercials and portions that are not. Referring to FIG. 10, the device may include an automatic commercial skipping feature that, when activated, will automatically skip or otherwise fast-forward through the identified segments based upon the data provided. In this manner, no user intervention is required to effectively bypass commercials or otherwise undesirable portions of the video content. It is to be understood that the users/devices forwarding the data to the server (or other devices) may be the same as, or different from the users/devices using the data. Using this method, there is normally some unavoidable latency post-broadcast during which commercial-skipping behavior data is collected and analyzed, and inferred commercial segment data is then redistributed, after which commercials may be automatically skipped by the same or other viewers.

In another embodiment of the present invention the data from individual devices are provided directly to other devices. One or more of the devices may then process the associated data to determine the potential location of the commercials or otherwise undesirable content. The processed data may be used by the device processing the data or transferred to other devices. In this manner separate data analysis, aggregation, or distribution servers may not be necessary, as all (or a portion thereof) the processing may be done by the devices themselves by sharing the data and the potential distribution of processed data between devices, if desired.

Another embodiment of the present invention may include the use of video signal analysis together with the general identification of the start and/or end of a commercial. With the general identification of the start and/or end of a commercial the system may then look for characteristics in the region of the start and end to more precisely determine the start and/or end of the commercial segment. The characteristics that may indicate the start and/or end of a commercial segment may include, for example, a black frame or a significant histogram difference between frames.

The data obtained from the user, the device, and/or the service may include, for example, the program name, the broadcast time, the playback time on the device, the fast-forward times, the fast forward duration, the skip-advance times, the skip-advance durations, the user identification, the channel number, and the user region. For example, some satellite broadcast providers divide a geographic region into multiple regions which may provide programming at different times. Also, broadcast cable may include different latencies in the broadcast to different regions of the country. Moreover, different content providers may modify the broadcast to insert additional commercials or remove commercials during the broadcast, in addition to modification of the broadcast itself. Accordingly, it is beneficial to have sufficient identification of the region where the program was broadcast, including which broadcast provider, if desired.

Another embodiment of the invention includes replacing commercials with user specific commercials, based for example, on the user's profile and data. In addition, the existing or replaced commercials may be supplemented with advertisements, preferably personalized, immediately before and/or after the commercial. The advertisements are preferably of a shorter duration than the commercial immediately before or after the advertisement.

Based upon the model of computed modal latency, the system may make inferences about the amount of time it generally takes users to get to the fast-forward button or ship ahead feature when they desire to skip some content. Based upon this latency, the system has information regarding how much of the first commercial is effectively unavoidable when a commercial-skip feature is turned off or is not available. In addition, the system may make assumptions about the amount of the first commercial that would be skipped over if the fast-forward sequence or skip feature is initiated (i.e., if we're going to fast-forward or skip, then the user is committing to fast-forward or skip over a certain minimum amount of the video content. Therefore, the system may sum the minimum fast-forward or skip interval together with the general time-to-hit-the fast-forward or skip duration, to determine what may be referred to as the minimum unavoidable commercial duration. Broadcasters may use this unavoidable commercial duration to offer new standard commercial segment lengths, to sequence commercials within commercial blocks based on commercial duration, and to charge a premium for unavoidable commercial broadcast time segments.

In many cases, broadcasters depend on ad revenue for their major source of income. As a general rule, users with PVRs don't watch many advertisements, because they can generally jump over them, skip over them, or automatically block them out. Therefore, as PVRs become increasingly popular it is reasonable to expect broadcasters to eliminate the fade-to-black and other signal hints of future commercials as much as possible. Further, broadcasters may tend to reduce ad block length to encourage viewing or otherwise confuse commercial detection systems. However, broadcasters are currently unaware how much can they reduce the ad block length. The present invention uniquely determines the minimum commercial segment length, which may be used to determine useful short-commercial segment lengths. In addition this may determine the minimum “hook” portion length (catch the viewer's attention and convince them not to skip the rest), as that may be used to get people to watch commercials that are longer than the systems minimal segment length. Based upon this data broadcasters may accommodate the viewer in other ways. Broadcasters may, in cooperation with PVR service providers if desired, offer different commercial-skipping service levels. After a couple of hours or days post-broadcast, the manual-commercial-skipping behavior data becomes available for analysis and the automatic commercial-skipping service levels may be provided. After a couple of hours or days the commercial data becomes available and the service levels may be provided. At Filtering Level 0 (no payment to the broadcaster), advertisements are not filtered at all. The first advertisement in a commercial block may be a short one (to try to get under the minimum radar, see Level one) followed by normal-length ones. At Filtering Level one, only short commercial segments are provided (as they are impossible to manually skip). The customer may have to pay for this filtering level, or perhaps this level of commercial-content reduction could be provided as an inducement to the viewer to provide some profiling information.

The customer may have to pay for this filtering level, or perhaps this is the inducement for providing some profiling information. And perhaps those short commercials are viewer-tuned ones instead of the broadcast ones. The viewer can't avoid them due to the minim length effect discussed above. But users are happier than with full blocks of ads. At Filter Level 2, all commercials are filtered. Normally the user would have to pay for this privilege, because otherwise the broadcaster has reduced a significant source of income. It is to be understood that any other type of laddered and non-laddered systems may likewise be used.

It is to be understood that the different fast-forward speed data from devices with multi-speed fast-forward features may be separately processed or otherwise used in a manner to provide greater accuracy of commercial detection. Also, another technique to improve the data accuracy is to modify the fast-forward-end time if the fast-forward-end command is immediately (or within a predetermined time period or otherwise thereafter) followed by a rewind command (indicating an overshoot). In such instances, the end of the rewind sequence may be called the more proper end of the fast-forward sequence, as it indicates the more accurate time of the end of the commercial segment. Similarly, if a fast-forward follows shortly after a fast forward stop, both data points may be ignored, if desired. This may indicate a false stop during the commercial.

Another option for determining the start and/or the end of commercial segments is to have one or more individuals indicate the start and/or the end of commercials in some manner, such as pressing a button. In this manner, the flow of presentation of the video does not necessarily need to be altered.

It is also be understood that “recording” may be done locally on the device or across a network on a network server, or otherwise. The recording may likewise simply be pointers to a new or existing video to indicate those portions that are desirable to the user. In this manner, if the video was stored on a network server, locally, or otherwise, one video may be stored for several users with the user simply indicating those portions of the video that are “recorded” for that user.

U.S. Pat. No. 6,233,389 discloses additional signal-analysis techniques that may be used, hereby incorporated by reference herein.

What is claimed:

1. A method for identifying a segment of a video comprising:
(a) identification of a first event with a first recording device for said video, wherein said first event is characterized by presenting a portion of a video in less time than normal;
(b) identification of a second event with a second recording device for said video, wherein said second event is characterized by presenting a portion of a video in less time than normal;
(c) processing said first event and said second event to identify a third event of said video; and
(d) identification of said third event within said video with a third recording device for said video.

2. The method of claim 1 wherein said presenting a portion of a video in less time than normal is as a result of fast forwarding said video.

3. The method of claim 1 wherein said presenting a portion of a video in less time than normal is as a result of skipping a portion of said video.

4. The method of claim 1 wherein said first event includes at least a portion of a commercial.

5. The method of claim 4 wherein said second event includes at least a portion of a commercial.

6. The method of claim 5 wherein said third event includes at least a portion of a commercial.

7. The method of claim 1 wherein said processing of said first event and said second event is performed by a server.

8. The method of claim 7 wherein said first event together with information regarding said video and said second event together with information regarding said video is provided to said server.

9. The method of claim 8 wherein said third event is provided by said server to said third recording device.

10. The method of claim 1 wherein a third device presenting said video is free from presenting a portion of said video based upon said identification of said third event.

11. The method of claim 10 wherein said third event is a commercial.

12. The method of claim 1 wherein said first recording device, said second recording device, and said third recording device are remotely located from one another.

13. The method of claim 12 wherein said processing is performed by a server.

14. The method of claim 12 wherein said processing is performed by another said recording device.

15. The method of claim 1 wherein said identification of said third event is further characterized by identifying a black frame of said video.

16. The method of claim 1 wherein said identification of said third event is further characterized by identifying a scene change of said video.

17. A system for identifying a segment of a video comprising:
(a) a processing system receiving an identification of a first event from a first recording device for said video, wherein said first event is characterized by presenting a portion of a video in less time than normal;
(b) said processing system receiving an identification of a second event from a second recording device for said video, wherein said second event is characterized by presenting a portion of a video in less time than normal;
(c) said processing system processing said first event and said second event to identify a third event of said video; and
(d) said processing device providing data to a third recording device indicating said third event within said video.

18. The system method of claim 17 wherein said presenting a portion of a video in less time than normal is as a result of fast forwarding said video.

19. The system of claim 17 wherein said presenting a portion of a video in less time than normal is as a result of skipping a portion of said video.

20. The system of claim 17 wherein said first event includes at least a portion of a commercial.

21. The system of claim 20 wherein said second event includes at least a portion of a commercial.

22. The system of claim 21 wherein said third event includes at least a portion of a commercial.

23. The system of claim 17 wherein said processing of said first event and said second event is performed by a server.

24. The system of claim 23 wherein said first event together with information regarding said video and said second event together with information regarding said video is provided to said server.

25. The system of claim 24 wherein said third event is provided by said server to said third recording device.

26. The system of claim 17 wherein a third device presenting said video is free from presenting a portion of said video based upon said identification of said third event.

27. The system of claim 26 wherein said third event is a commercial.

28. The system of claim 17 wherein said first recording device, said second recording device, and said third recording device are remotely located from one another.

29. The system of claim 28 wherein said processing is performed by a server.

30. The system of claim 28 wherein said processing is performed by another said recording device.

31. The system of claim 17 wherein said identification of said third event is further characterized by identifying a black frame of said video.

32. The system of claim 17 wherein said identification of said third event is further characterized by identifying a scene change of said video.

33. A method for identifying a segment of a video comprising:
(a) identification of a first event with a first device for said video, wherein said first event is characterized by a commercial segment;
(b) identification of a second event with a second device for said video, wherein said second event is characterized by a commercial segment;
(c) processing said first event and said second event to identify a third event of said video; and
(d) identification of said third event within said video with a third device for said video.
